(19) United States
(12) Patent Application Publication
(10) Pub. No.: US 2007/0041040 A1
(43) Pub. Date: Feb. 22, 2007

(54) Image forming apparatus enabling performing direct print and recording medium storing program

(75) Inventor: Masahiro Ozawa, Tokyo (JP)

Correspondence Address: FINNEGAN, HENDERSON, FARABOW, GARRETT & DUNNER;LLP, 901 NEW YORK AVENUE, NW, WASHINGTON, DC, 20001-4413, US

(73) Assignee: KONICA MINOLTA BUSINESS TECHNOLOGIES, INC.

(21) Appl. No.: 11/281,482

(22) Filed: Nov. 18, 2005

(30) Foreign Application Priority Data
Aug. 19, 2005 (JP) 2005-238561

(51) Int. Cl. G06F 3/12

(52) U.S. Cl. 358/1.15; 358/1.14

(57) ABSTRACT

Disclosed is an image forming apparatus equipped with a terminal to which an external device is connected to enable performing direct print; a print unit executing print; and a control unit controlling the image forming apparatus. The control unit judges whether the device connected to the terminal is a mass-storage device or not, discriminates a file kind of a file by analyzing the file stored in the device if the device is judged to be the mass-storage device, and makes the print unit execute print based on the file if the file kind of the file is a printable file kind as a result of the discrimination.

### BACKGROUND OF THE INVENTION

1. Field of the Invention

The present invention relates to an image forming apparatus enabling performing direct print by connecting an external device typically represented by a USB device, and a recording medium storing a program.

2. Description of Related Art

As a conventional method of printing an image photographed with a photographing apparatus such as a digital camera and a video camera, there has been a method in which image data is first transmitted to a personal computer (PC) through a serial interface such as RS-232C, and a memory card. Then, image data is processed by the PC correspondingly to the printing form of a printing apparatus. The processed image data is transmitted as printing data to the printing apparatus connected to the PC through a parallel interface such as Centronics or a serial interface such as Universal Serial Bus (USB). Then, print is performed based on the printing data.

That is, in order to print image data, it is indispensable for a user to own a PC, and the PC must be necessarily started in time of print. Consequently, a user who does not own any PC's, even though the user owns a photographing apparatus such as a digital camera or a video camera, cannot print any photographed images unless the user newly purchases a PC.

A system in the form called as a dye sublimate type video printer which can perform print with a printing apparatus directly by connecting a photographing apparatus with the printing apparatus directly without using any PC's (hereinafter referred to as a direct print system) accordingly becomes more common. Moreover, in the latest printers, it becomes possible to perform direct print in the file format of PC's such as Joint Photographic Experts Group (JPEG) and Portable Document Format (PDF) as well as the print in conformity with printer languages such as Post Script (PS) and Printer Control Language (PCL) (refer to JP-2000-181674A).

However, because the judgment of the kind of a file has been conventionally made only by the extension of the file, which is a character string attached to the tail of the file name, as for a USB memory saving data in various file formats, there is a problem in which it is impossible to judge which kind of file format data is saved therein. Moreover, in the direct print in the file format of a PC, there is another problem in which the file formats in which the direct print can be performed are frequently limited and further print settings of printing paper and the like are also frequently limited.

### SUMMARY

The present invention was made in view of the problems mentioned above. It is an object of the invention to provide an image forming apparatus capable of dealing with the direct print by many languages and in many file formats correctly at the same level as that of the ordinal print processing. Moreover, the invention provides an image forming apparatus enabling the direct print in accordance with estimation.

In order to solve the above problem, an image forming apparatus reflecting one embodiment according to a first aspect of the invention comprises:

a terminal to which an external device is connected to enable performing direct print;

a print unit executing print; and

a control unit controlling the image forming apparatus, wherein the control unit judges whether the device connected to the terminal is a mass-storage device or not, discriminates a file kind of a file by analyzing the file stored in the device if the device is judged to be the mass-storage device, and makes the print unit execute print based on the file if the file kind of the file is discriminated as a printable file kind.

Preferably, the control unit discriminates at least one of a kind of a printer description language and a kind of a file format as the file kind of the file.

Preferably, the control unit discriminates the file kind of the file by analyzing data positioned at leading of the file.

Preferably, the control unit discriminates the file kind of the file by analyzing a character string positioned at the leading of the file as the data.

Preferably, the control unit obtains a character string from the file to discriminate the file kind of the file based on the obtained character string when the file kind of the file cannot be discriminated by the analysis of the data.

Preferably, the control unit further analyzes another file kind included in the file after discriminating the file kind of the file by the analysis of the data.

Preferably, the control unit further analyzes another file kind when the file kind of the file is judged as PJL as a result of the analysis of the data.

Preferably, the control unit obtains print settings by further analyzing the file when the file kind of the file is discriminated as PJL.

Preferably, the control unit makes the print unit execute the print based on the file pursuant to the obtained print settings.

Preferably, the control unit judges whether the file kind of the file is one enabling the direct print thereof or not, and makes the print unit execute print based on the file without an instruction of a user when the file is judged to be the one enabling the direct print thereof.

### BRIEF DESCRIPTION OF THE DRAWINGS

The present invention will become more fully understood from the detailed description given hereinafter and the accompanying drawings which are given by way of illustration only, and thus are not intended as a definition of the limits of the scope of the invention, and wherein:

FIG. 1 is a diagram showing the configuration of the principal part of an image forming apparatus according to the embodiment;

FIG. 2 is a flowchart showing a series of processing executed in the image forming apparatus according to the embodiment;

FIG. 3 is a flowchart showing storage device connection recognition processing executed in the image forming apparatus according to the embodiment;

FIG. 4 is a flowchart showing automatic language discrimination processing executed in the image forming apparatus according to the embodiment;

FIG. 5 is a flowchart showing print setting obtainment processing executed in the image forming apparatus according to the embodiment;

FIG. 6 is a view showing an example of the schematic configuration of an operation panel;

FIG. 7 is a flowchart showing print processing executed in the image forming apparatus according to the embodiment;

FIG. 8 is a flowchart showing a series of processing executed in an image forming apparatus according to a modified example; and

FIG. 9 is a flowchart showing automatic interrupt print processing executed in the image forming apparatus according to the modified example.

### DETAILED DESCRIPTION OF THE PREFERRED EMBODIMENTS

In the following, with reference to the attached drawings, the preferred embodiment of the present invention is described in detail.

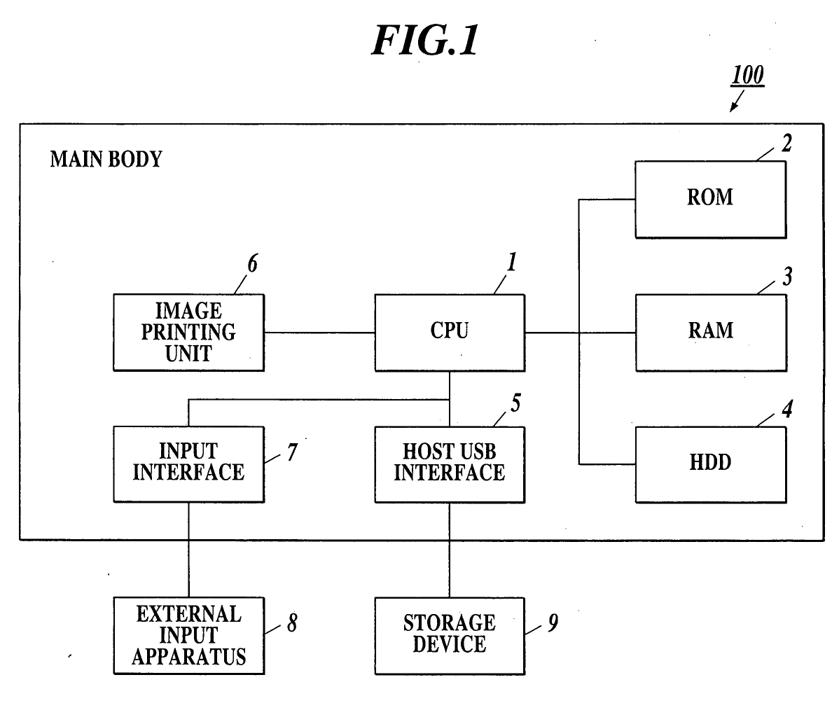

The configuration of the principal part of a direct printing apparatus (hereinafter referred to as a printer) 100 is shown in FIG. 1. As shown in FIG. 1, the printer 100 is composed of a main body, and an external input apparatus 8 and a storage device 9, both connected to the main body. Moreover, the main body is composed of a CPU 1, a ROM 2, a RAM 3, a HDD 4, a host USB interface 5 (a USB terminal), an image printing unit 6 and an input interface 7.

The CPU 1 is a central processing unit executing the processing based on a predetermined program in obedience to an input instruction, and performing instructions to respective functional units and transfer of data. In concrete terms, the CPU 1 reads a program stored in the ROM 2 according to an input signal input from the external input apparatus 8, and executes the processing pursuant to the read program. For example, when the storage device 9 is connected to the host USB interface 5, the CPU 1 starts a judgment of whether the connected storage device is a USB device or not, and executes storage device connection recognition processing.

The ROM 2 stores the programs for realizing the various functions relative to the operations of the printer 100. These programs are programs without the necessity of being rewritten, or programs which must not be rewritten.

The RAM 3 expands the various programs executed by the CPU 1 into a program storing area. The RAM 3 temporarily stores data such as a processing result produced at the time of execution of various programs into a work area. The RAM 3 of the printer 100 according to the present embodiment temporarily saves an image stored in a file owned by the storage device 9.

The hard disk (HDD) 4 stores programs, job data and the like. In concrete terms, when the storage device 9 is connected, a file saved in the storage device 9 is stored in DB storage means. Consequently, the file once stored in the DB storage means can be printed again even if the storage device 9 is not connected to the printer 100. Because the data stored in the DB storage means can be rewritten repeatedly, the data having become unnecessary is deleted, and only the data required is always stored.

The host USB interface 5 is an interface for connecting the storage device 9 such as a USB memory to the printer 100. As the storage device 9, a USB memory, a HDD, a digital camera, a flash memory card and the like can be used.

The input interface 7 is an interface for connecting the printer 100 to the external input apparatus 8. As the external input apparatus 8, for example, a personal computer (PC) is connected through a network. A locally connected PC and the like may be connected to the input interface 7.

The image printing unit 6 prints image data on a sheet of printing paper in a predetermined print system (for example, a laser beam system) pursuant to a print control signal from the CPU 1. When an operation of a print start is input by a user, the CPU 1 controls the operation of the image printing unit 6 based on the input signal. Moreover, in automatic interrupt print, the CPU 1 starts print by controlling the operation of the image printing unit 6 based on the print settings obtained by print setting obtainment processing without waiting any instructions of a user.

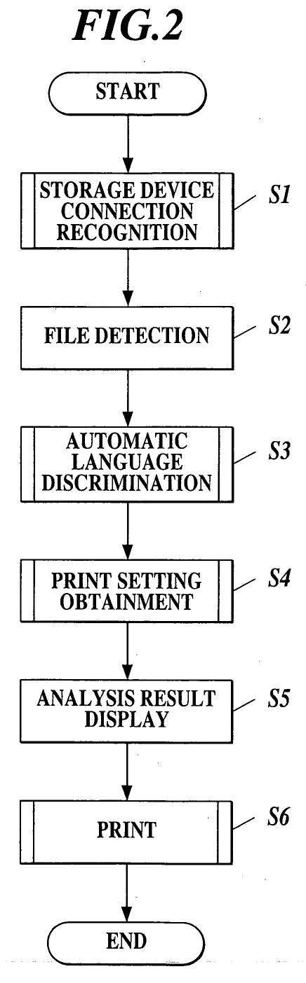

With reference to the flowchart in FIG. 2, the print processing of the printer 100 is described.

First, when, for example, a USB device among the storage devices 9 is connected to the host USB interface 5 of the printer 100, the CPU 1 of the printer 100 executes the recognition processing of the connected USB device (Step S1).

After the execution of the recognition processing of the connected storage device at Step S1, the CPU 1 detects the files stored in the storage device (Step S2).

Here, the classification of the USB devices is described. The classification called as a “class” is performed to the USB devices, and control means is standardized for each class. Consequently, the device belonging to the same class can fundamentally be supported by a single class driver irrespective of the differences of makers or products. The class driver is the software incorporated in the printer side for controlling the USB device. The main classes are shown below.

o: no specifications

1: audio

2: communication (modem, LAN and the like)

3: human interface device (HID) (keyboard, mouse, joystick and the like)

7: printer

8: mass storage (large capacity storage) (FDD, CD/DVD, removable disk and the like)

9: hub

When it is recognized that the connected USB device is a storage device at Step S1, it becomes possible to access the files stored in the USB device (Step S2). In the file detection at Step S2, the CPU 1 performs the detection of the files stored in the USB device. Incidentally, when it is judged that the connected USB device is not a mass-storage device at Step S1, the CPU 1 does not execute the file detection at Step S2.

After the execution of the file detection at Step S2, the CPU 1 performs automatic language discrimination processing to each of the detected files, and the CPU 1 judges whether the files are directly printable files or not (Step S3). When the CPU 1 has obtained the file kinds, i.e. the printer languages and the file formats, of the files and found included print settings as the results of the automatic language discrimination processing at Step S3, the CPU 1 obtains the print settings (Step S4).

When the CPU 1 has obtained the print settings at Step S4, the CPU 1 displays the analysis results of the automatic language judgments on a display screen 15 of an operation panel 10 (Step S5). Incidentally, at this time, the CPU 1 displays the names of the files stored in the USB device and the propriety of their direct print on the display screen 15. Furthermore, when the CPU 1 has obtained their print settings, the CPU 1 also displays the print settings.

When the CPU 1 displays the analysis results of the automatic language judgments on the display screen 15 of the operation panel 10 at Step S5, the user looks at the display screen and selects a file the direct print of which the user desires among the files displayed as a list. Then, when the CPU 1 receives the selection operation by the user, the CPU 1 starts print processing (Step S6).

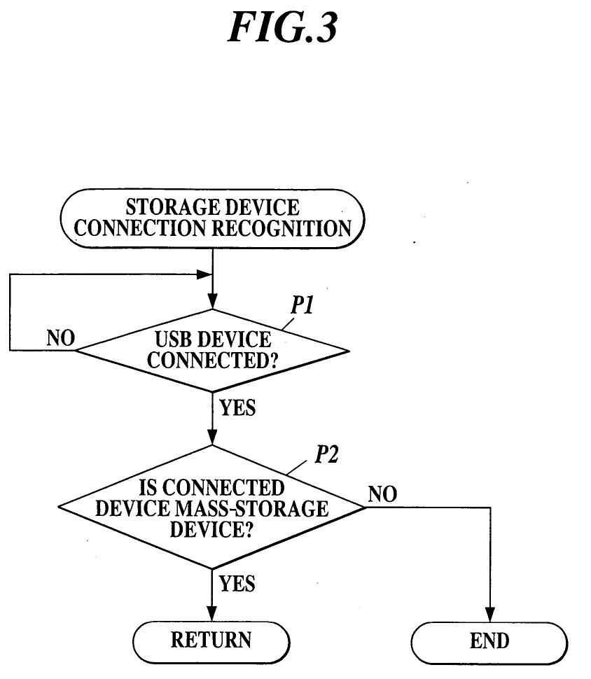

In the following, each processing is described in detail. First, with reference to the flowchart of FIG. 3, the storage device connection recognition processing at Step S1 of FIG. 1 is described.

When the CPU 1 starts the storage device connection recognition processing, the CPU 1 first judges whether a USB device has been connected to the host USB interface 5 of the printer 100 (Step P1). When the CPU 1 judges at Step P1 that no USB devices are connected (Step P1; NO), the CPU 1 again repeats the judgment at Step P1. When the CPU 1 judges at Step P1 that a USB device has been connected (Step P1: YES), the CPU 1 judges whether the connected USB device is a mass-storage device or not (Step P2).

When the CPU 1 judges at Step P2 that the connected USB device is not a mass-storage device (Step P2; NO), the CPU 1 terminates the storage device connection recognition processing. When the CPU 1 judges at Step P2 that the connected USB device is a mass-storage device (Step P2; YES), the CPU 1 returns the print processing to the processing of the flowchart in FIG. 2, and the CPU 1 executes the detection of the files stored in the USB device (Step S2).

Next, the automatic language discrimination processing at Step S3 of FIG. 2 is described. As shown below, in the automatic language discrimination processing, the CPU 1 executes the distinction of a print description language at two steps.

At Step S2 of FIG. 2, when the CPU 1 detects some file, the CPU 1 analyzes the leading byte string of the detected file. The description is first given to a case where it is possible to discriminate the print description language by examining the leading several bytes of a file in the analysis of the leading byte string. When the CPU 1 has detected “@PJL” at the leading of a file as a result of the analysis of the file, the CPU 1 discriminate that the print description language is PJL. When a file begins with “%” or “ˆD %”, the CPU 1 discriminates that the file is Postscript, which is a print description language. Moreover, when the 7^{th} to 10^{th} bytes in the leading of a file begins with “JFIF” or “oxFF oxD8”, the CPU 1 judges that the file is a JPEG file.

Next, the description is given to a case where a printer language and a file format cannot be judged only by the analysis of the leading of a file. In this case, the CPU1 judges the printer language and the file format from a character string which can be detected from the file. For example, the CPU 1 obtains a character string every 1 KB from the leading, and the CPU 1 analyzes whether a byte string peculiar to each print language and each file format exists or not in the character string. When the CPU 1 detects a certain number or more of byte strings peculiar to a specific printer language and a specific file format in a character string, the CPU 1 judges that the character string is that of the printer language and the file format, respectively. For example, the CPU 1 counts the number of the character strings of “copy”, “def”, “dict”, “moveto” and the like, which are operators of Postscript. When the CPU 1 has detected the character strings of the number equal to a threshold value set in 512 KB of the leading or more, the CPU 1 judges the printer language as Postscript.

Moreover, PJL, which is the print description language describing print settings, is described in the head of a print description language describing image rendering, such as PCL, TIFF or JPEG, independently from the print description language. When the CPU 1 has discriminated a print description language as PJL as a result of the first print description language discrimination, the CPU 1 accordingly further performs the language discrimination of the print description language and the file format following the PJL.

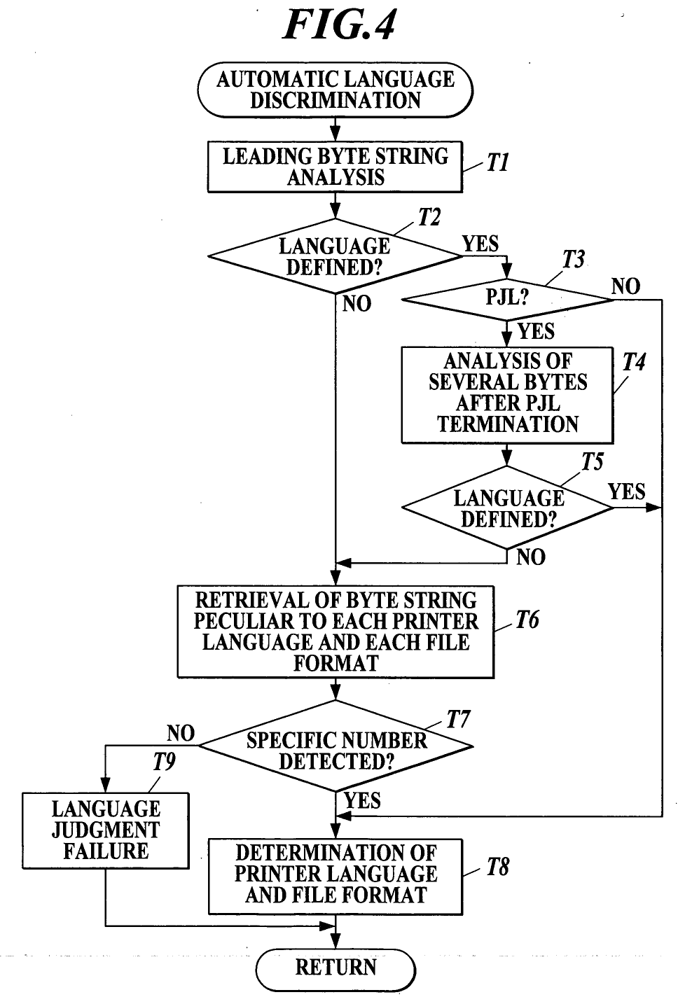

A flowchart showing the automatic language discrimination processing mentioned above is shown in FIG. 4.

First, when the CPU 1 has detected a file at Step S2 in FIG. 2, the CPU 1 analyzes the leading byte string of the detected file (Step T1). After the execution of the leading byte string analysis at Step T1, the CPU 1 judges whether a language has been defined based on the result of the analysis or not (Step T2).

When the CPU 1 judges at Step T2 that the CPU 1 had been able to define a language (Step T2; YES), the CPU 1 discriminates whether the defined print description language is PJL or not (Step T3). When the CPU 1 judges at Step T3 that the print description language defined at Step T2 is PJL (Step T3; YES), the CPU 1 analyzes the several bytes after the PJL termination (Step T4). After the analysis of the several bytes after the PJL termination at Step T4, the CPU 1 again judges whether a language has been able to be defined or not (Step T5).

When the CPU 1 has not be able to define a language at Step T5 (Step T5; NO), or when the CPU 1 has not be able to define a language at Step T2 (Step T2; NO), the CPU 1 retrieves the byte strings peculiar to the respective printer languages and the respective file formats (Step T6).

After the retrieval of the byte strings peculiar to the respective printer languages and the respective file formats at Step T6, the CPU 1 judges whether a specific number of the byte strings peculiar to a specific printer language and a specific file format has been able to be detected or not (Step T7). When the CPU 1 has been able to detect the specific number of the byte strings peculiar to the specific printer language and the specific file format at Step T7 (Step T7; YES), the CPU 1 determines the printer language and the file format (Step T8).

On the other hand, when the defined language is not PJL at Step T3 (Step T3; NO), or when the CPU 1 has been able to define at Step T5 that the print description language is PJL (Step T5; YES), the CPU 1 also similarly determines the printer language and the file format determined (Step T8: second print description language distinction processing). After the determination of the printer language and the file format at Step T8, the CPU 1 returns the print processing to the processing shown in the flowchart in FIG. 2, and executes the print setting obtainment processing (Step S4).

When the CPU 1 has not been able to detect the specific number of the byte strings peculiar to any specific printer languages and any specific file formats at Step T7 (Step T7; NO), the CPU 1 judges that the language judgment has failed (Step T9), and the CPU 1 performs the print processing on the supposition of the printer language being a specific printer language, for example, PCL. Alternatively, the CPU 1 may treat the file as the one the direct print of which is impossible. When the CPU 1 has judged at Step T9 that the language judgment has failed and has processed the print processing on the supposition of the printer language being the specific printer language, the CPU 1 returns the print processing to the processing of the flowchart shown in FIG. 2, and executes the print setting obtainment processing (Step S4).

As mentioned above, when the connected device is a mass-storage device, by analyzing the leading byte string of the file stored in the mass-storage device, and by discriminating the print description language, the printer can correctly judges the contents of the file without being bound by the extension of the file, and the printer can perform exact direct print.

Moreover, by performing the discrimination of each of the print description languages at two steps, the printer can discriminate the printer languages and the file formats of Postscript, PCL, TIFF, JPEG and the like which follow PJL describing print settings. Consequently, the printer can deal with the direct print by many languages and many file formats, and can perform print pursuant to the print settings in accordance with estimation.

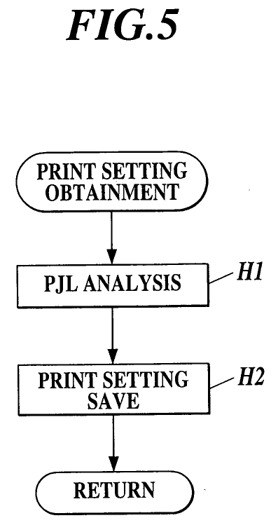

Next, with reference to the flowchart of FIG. 5, the processing of the print setting obtainment is described.

When the CPU 1 has judged that the detected file is described pursuant to PJL as a result of the automatic language discrimination processing, the CPU 1 first analyzes PJL (Step H1). After the analysis of PJL at Step H1, the CPU 1 obtains print settings based on the analysis. For example, when there are specifications described below, the CPU 1 set the print settings as follows: both side print, number of copies: 3, and paper size: A4.

PJL SET DUPLEX=TRUE

PJL SET COPIES=3

PJL SET PAPER=A4

Then the CPU 1 stores the print settings in the HDD 4 (Step H2). After the CPU 1 has saved the print settings at Step H2, the CPU 1 returns the print processing to the processing of the flowchart shown in FIG. 2, and displays the analysis result (Step S5).

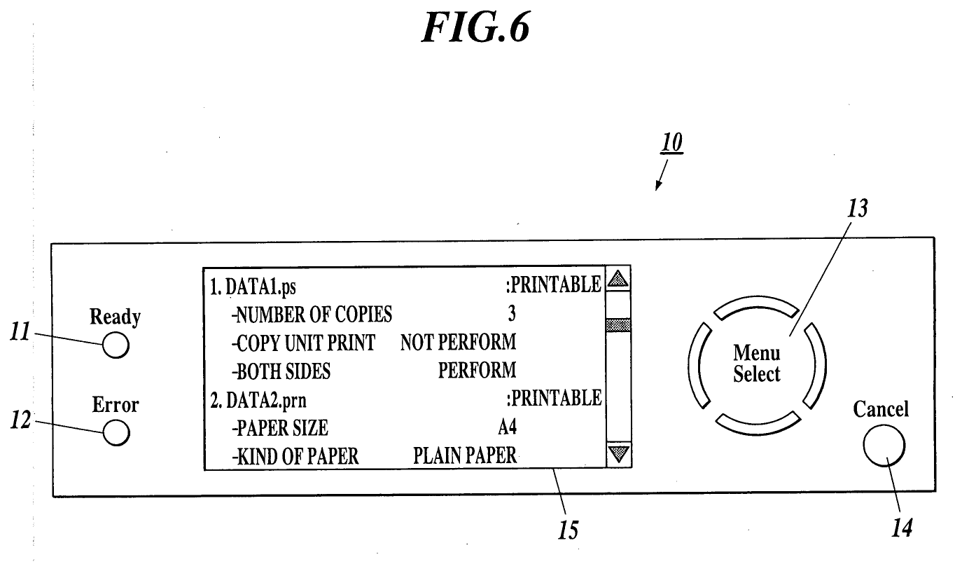

An example of the display displayed on the display screen 15 of the operation panel 10 is shown in FIG. 6. As shown in FIG. 6, the operation panel 10 is equipped with various function keys such as a ready key 11, an error key 12, a menu selection key 13 and a cancel key 14. Then, the print settings obtained by the analysis of PJL are displayed on the display screen 15. In the display screen 15, in addition to the file names, the propriety of the direct print and the print settings in the case where the print settings are obtained are together displayed. A user selects a file the direct print of which is wanted by the key operation of the menu selection key 13 among the files displayed in a list, and prints the file.

For example, as shown in FIG. 6, the print settings of data 1 are settings in which the number of print copies is 3; copy unit print is not performed; and both side print is performed because both sides are performed. And, a state in which the direct print is possible is shown. The print settings of data 2 are that the paper size is A4 and the kind of paper is plain, and the direct print is in the possible state similar to data 1. The user confirms the print settings displayed on the display screen 15 of the operation panel 10, and when the user alters the print settings, the user can perform the alteration with the menu selection key 13.

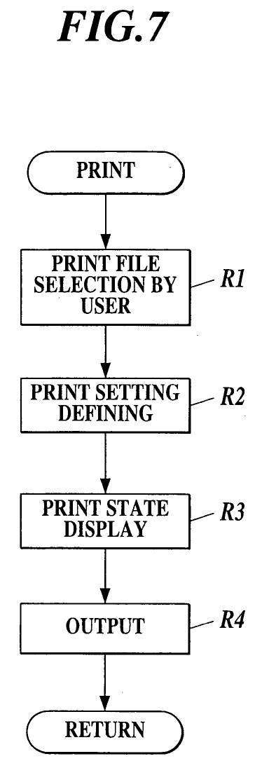

Next, with reference to the flowchart of FIG. 7, print processing is described. When a print file is selected by the user in the list of the files the direct print of which can be performed, which list is displayed on the display screen 15, the CPU 1 of the printer 100 receives the selection signal (Step R1). At this time, a paper size, the number of print copies, the performance or the non-performance of the copy unit print, both side print setting, color setting and the like are specified.

Incidentally, as for the items obtained by the print settings (FIG. 6), the CPU 1 uses the values of the obtained items. When the CPU 1 has not be able to obtain the print settings, or as for the items which could not been obtained, the CPU 1 uses initial values. The initial values are previously set by the user on the operation pane 10, or by using a setting tool through a network. Incidentally, the initial values may not be set previously, and may be instructed by the user every print specification time.

When the CPU 1 receives the selection signal and various setting signals by the operations of the user at Step R1, the CPU 1 defines the selected print settings (Step R2). After the defining of the print settings at Step R2, the CPU 1 displays the print state on the display screen 15 of the operation panel 10 (Step R3). When the print state is displayed on the displayed screen 15 of the operation panel 10 at Step R3, the user confirms the display. Then, when the CPU 1 receives an operation signal by the user, the CPU 1 outputs the selected file (Step R4).

In the case where there is a function not supported by the printer 100 in the print settings obtained from the file, the printer 100 automatically uses the initial values to perform print pursuant to the function. Alternatively, when there is the not supported print setting, the printer 100 may perform a display of not supporting the specified print setting on the display screen of the operation panel 10, and may suspend the print. The not supported function corresponds to a function of a printer, for example, in the case where, although the both side print is set in the print settings, the printer does not support the both side print function. The items of the print settings are the paper size, the kind of paper, the number of print copies, the performance or non-performance of copy unit print, both side print, color setting, resolution and the like.

As mentioned above, because it is possible to obtain print settings saved in a file stored in a device to perform the print based on the settings, it becomes possible to perform print based on the print settings previously set by a user without being limited to the initial values of the print settings set in a printer. Moreover, because the obtained settings can be altered with the operations of the operation panel, the user can always perform print pursuant to the desired settings without being limited by the first settings. Hence, the degree of freedom of the user is improved.

Next, a modified example of the printer 100 according to the embodiment is described. Because the configuration of the principal part and the operations of the respective units of the printer 100 according to the modified example are the same as those of the embodiment, their descriptions and their illustration are omitted. The printer 100 according to the embodiment performs the operation of obtaining the print settings (FIG. 2: Step S4) before displaying an analysis result to start print processing pursuant to an operation of a user. The printer 100 according to the modified example executes an operation of starting automatic interrupt print after print setting obtainment.

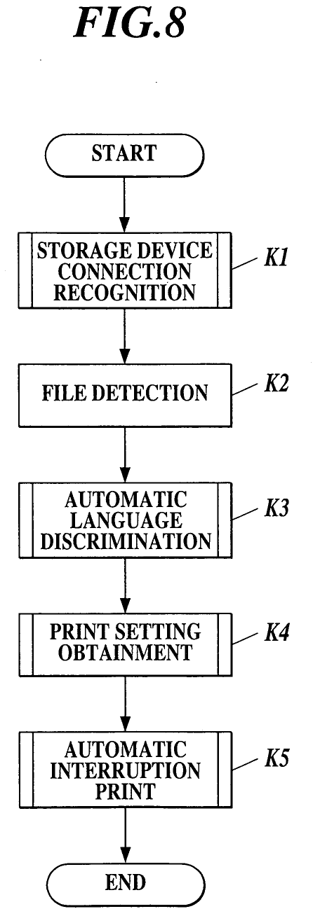

First, with reference to the flowchart of FIG. 8, the processing executed when a USB storage device is connected to the printer 100 according to the modified example is described.

First, when, for example, a USB device among the storage devices 9 is connected to the host USB interface 5 of the printer 100, the CPU 1 of the printer 100 executes the recognition processing of the connected USB device (Step K1).

After the execution of the recognition processing of the connected storage device at Step K1, the CPU 1 detects the files stored in the storage device (Step K2). Because the classification of the USB devices is the same as that of the embodiment, the description thereof is omitted.

When the CPU 1 has recognized at Step K1 that the connected USB device is a storage device, the CPU 1 becomes to be able to access the files stored in the USB device (Step K2). In the file detection at Step K2, the CPU 1 performs the detection of the files capable of being directly printed because the CPU 1 performs the detection of the files stored in the USB device. Incidentally, when the CPU 1 has judged at Step K1 that the connected USB device is not the mass-storage device, the CPU 1 does not execute the file detection at Step K2.

After the execution of the file detection at Step K2, the CPU 1 performs the automatic language discrimination processing to each of the detected files, and judges whether the file is the directly printable file or not (Step K3). When the CPU 1 has obtained the printer languages or the file formats of the files and found included print settings as the results of the automatic language discrimination processing at Step K3, the CPU 1 obtains the print settings (Step K1).

When the CPU 1 has obtained the print settings at Step K4, the CPU 1 starts automatic interrupt print of automatically printing a file judged to be capable of being directly printed as a result of the automatic language judgment (Step K5).

Incidentally, the storage device connection recognition processing (Step K1), the automatic language discrimination processing (Step K3) and the print setting obtainment processing (Step K4) are the same as those of the embodiment, their descriptions are omitted.

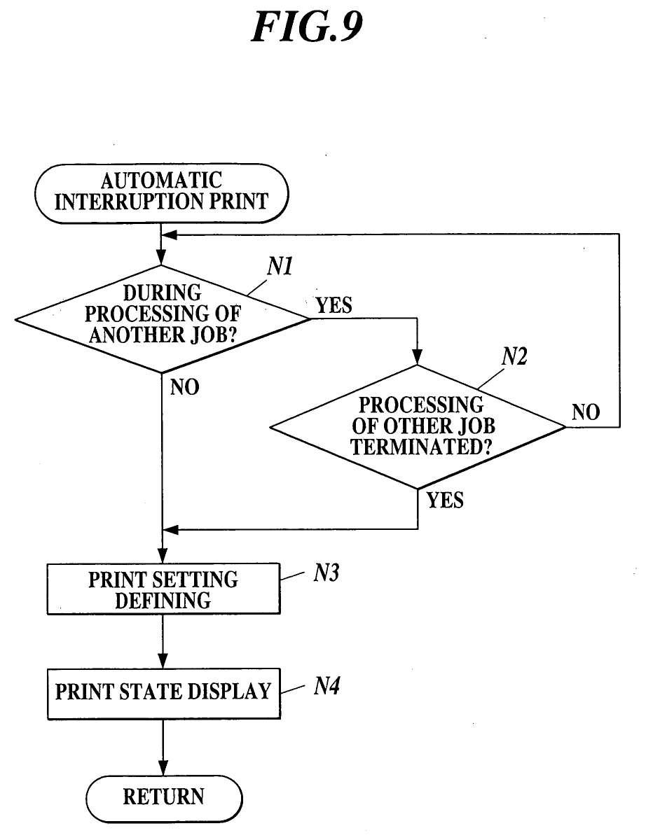

Next, with reference to the flowchart of FIG. 9, the automatic interrupt print processing is described. In the automatic interrupt print processing, the CPU 1 starts the print of all of the files judged to be able to be directly printed in the automatic language discrimination processing without any print instructions by the user.

First, the CPU 1 judges whether another job is being processed or not (Step N1). When the CPU 1 has judged at Step N1 that the other job is being processed (Step N1; YES), the CPU 1 starts print after the end of the job. Accordingly, the CPU 1 judges whether the processing of the other job has ended or not (Step N2). Incidentally, when further job is continuously transmitted from the PC besides the job during the print, the CPU 1 does not accept the transmitted job, but performs the interrupt of the file in the USB storage device to print the file.

When the CPU 1 has judged at Step N2 that the processing of the other job is not terminated (Step N2; NO), the CPU 1 returns the print processing to Step N1, and again repeats the judgment at Step N1. When the CPU 1 has judged at Step N2 that the other job has been terminated (Step N2; YES), the CPU 1 defines print settings (Step N3). It is necessary to specify the paper size, the number of print copies, the performance or the non-performance of copy unit print, both side print setting, a color setting and the like before the definition of the print settings. With regard to the items obtained by the print setting obtainment processing, the CPU 1 uses the values of the obtained items. In the case where the CPU 1 could not obtain the print settings, or as for the items which could not be obtained, the CPU 1 uses initial values. The initial values are set by the user on the operation panel 10 or by using a setting tool through a network beforehand.

After the defining of the print settings at Step N3, the CPU 1 displays the print state on the display screen 15 of the operation panel 10 (Step N4). For example, the CPU 1 displays the operation state of the printer 100 on the display screen 15 of the operation panel 10 at the time of print. The CPU 1 displays “during processing”, “during print” and the contents of an error when the CPU i is analyzing a file, is performing the print processing to a sheet of printing paper, and finds the occurrence of an error, respectively. The processing in the case where there is a function not supported by the printer 100 in the print settings obtained from the file is the same as that of the embodiment.

As mentioned above, the modified example performs the automatic discrimination of files only by the connection of a device to a printer without any print instructions by a user. Thereby the modified example makes it possible to obtain the print settings saved in the files to automatically perform print pursuant to the print settings desired by the user. Hence, the user can perform print only by storing the files and the print settings of the files in a USB storage device beforehand. Consequently, not only the time of the user can be saved, but also the efficiency of the operations thereof can be improved.

For the present United States Application, the Japanese Patent Application No. Tokugan 2005-238561, which was filed with Japan Patent Office on Aug. 19, 2005 and is for claiming the Paris Convention priority for the present United States Application, serves as a basis for correcting translational and/or typographical errors.

What is claimed is:

1. An image forming apparatus comprising:
a terminal to which an external device is connected to enable performing direct print;
a print unit executing print; and
a control unit controlling the image forming apparatus,
wherein the control unit judges whether the device connected to the terminal is a mass-storage device or not, discriminates a file kind of a file by analyzing the file stored in the device if the device is judged to be the mass-storage device, and makes the print unit execute print based on the file if the file kind of the file is discriminated as a printable file kind as a result of the discrimination.

2. The image forming apparatus of claim 1, wherein the control unit discriminates at least one of a kind of a printer description language and a kind of a file format as the file kind of the file.

3. The image forming apparatus of claim 1, wherein the control unit discriminates the file kind of the file by analyzing data positioned at leading of the file.

4. The image forming apparatus of claim 3, wherein the control unit discriminates the file kind of the file by analyzing a character string positioned at the leading of the file as the data.

5. The image forming apparatus of claim 3, wherein the control unit obtains a character string from the file to discriminate the file kind of the file based on the obtained character string when the file kind of the file cannot be discriminated by the analysis of the data.

6. The image forming apparatus of claim 3, wherein the control unit further analyzes another file kind included in the file after discriminating the file kind of the file by the analysis of the data.

7. The image forming apparatus of claim 5, wherein the control unit further analyzes another file kind when the file kind of the file is judged as PJL as a result of the analysis of the data.

8. The image forming apparatus of claim 1, wherein the control unit obtains print settings by further analyzing the file when the file kind of the file is discriminated as PJL.

9. The image forming apparatus according to claim 7, wherein the control unit makes the print unit execute the print based on the file pursuant to the obtained print settings.

10. The image forming apparatus of claim 1, wherein the control unit judges whether the file kind of the file is one enabling the direct print thereof or not, and makes the print unit execute print based on the file without an instruction of a user when the file is judged to be the one enabling the direct print thereof.

11. A recording medium storing a control program stored in an image forming apparatus equipped with a terminal to which an external device is connected and a print unit executing print, the apparatus to enable performing direct print, the program executed by the control unit of the image forming apparatus, the program makes the control unit realize:
a function of judging whether the device connected to the terminal is a mass-storage device or not;
a function of discriminating a file kind of a file by analyzing the file stored in the device if the device is judged to be the mass-storage device; and
a function of making the print unit execute the print based on the file if it is judged that the file has a printable file kind as a result of the discrimination.
